(19) United States
(12) Patent Application Publication
(10) Pub. No.: US 2015/0317568 A1
(43) Pub. Date: Nov. 5, 2015

(54) SYSTEM AND METHOD FOR FLEXIBLE CARPOOLING IN A WORK CONTEXT

(71) Applicant: Xerox Corporation, Norwalk, CT (US)

(72) Inventors: MARIA ANTONIETTA GRASSO, GRENOBLE (FR); CAROLINE BRUN, GRENOBLE (FR); JUTTA KATHARINA WILLAMOWSKI, GRENOBLE (FR); STEFANIA CASTELLANI, MEYLAN (FR)

(73) Assignee: Xerox Corporation, Norwalk, CT (US)

(21) Appl. No.: 14/265,874

(22) Filed: Apr. 30, 2014

(51) Int. Cl. G06Q 10/02; G06Q 10/10

(52) U.S. Cl. CPC G06Q 10/02; G06Q 10/1093

(57) ABSTRACT

A computer implemented method of forming carpools. Lists of participants in a rideshare environment are maintained. The participants are members of a private group and have privileges based on membership. A location of a participant is automatically determined based on a location detection method. A driver from the list of participants is automatically identified based on a current location of the driver. The driver proposes a trip comprising an approximate start time, approximate start location, end location, and number of available seats. Requests for transportation are received from passengers who are participants on the list of participants. For each available seat, the requests for transportation are automatically matched with the trip based on the approximate start time, the approximate start location, or the end location. Only certain passengers are matched with certain drivers. The matching identifies proposed riders. A finalized start time and finalized start location are negotiated between the proposed riders and the driver. The driver publishes the finalized start time and finalized start location. The proposed riders are automatically notified of the finalized start time, and the finalized start location.

### BACKGROUND

The present disclosure relates to carpooling, and more specifically, to systems and methods to facilitate carpooling for recurrent journeys in a work context.

Carpooling (also known as car-sharing, ride-sharing, lift-sharing and covoiturage) is the sharing of car journeys so that more than one person travels in a car. While car sharing coordinating systems have been available even before the Internet, it is with the raise of the interactive Web that such systems have multiplied in number. However, existing systems still present many problems.

High transaction costs that are common to many rideshare systems may refrain possible users from engaging with ride sharing. Indeed, organizing a ride share trip requires a lot of overhead, first to execute an initial search for appropriate matching ride sharing partners, and afterwards to interact with the individual partners via phone or Email to share the necessary information and establish the final schedule. The resulting cost benefit ratio is often not reasonable, especially for shorter trips. To become acceptable these transaction costs must be reduced to the minimum, by making the interaction with the system more efficient for its users and adapting it to their actual context. Otherwise ride sharing is only worthwhile for long distance trips planned in advance or for recurring fixed rideshare arrangements that, once organized, are often handled directly between the partners, without further system support which results in difficulties to measure the impact and occurrence of car sharing.

Indeed, when work settings present recurrent work patterns, but with a degree of variability around arrival and departure times, fixed car sharing schedules, on one hand, are deemed too rigid, while, on the other hand, real time car sharing, i.e. arranging last minute opportunities, is also unacceptable, given the lack of critical mass to ensure that there will always be an available ride.

Currently existing carpooling systems often support both, in advance search and booking of rides or last minute real time discovery of already active rides. However, these complementary functionalities are proposed side-by-side and not well integrated. Thus, these systems still do not propose sufficiently flexible and convenient solutions; they still involve too high transaction costs to reach an appropriate service level. The solution we propose in the following palliates these issues.

### SUMMARY

Disclosed herein is a system and method that supports flexible carpooling among colleagues in a work organization, mixing stable and last minute arrangements. The systems and methods allow providers to publish a trip initially with only approximate leaving time and location and to specify the precise leaving time and location later (when it is known). The concepts herein enable the system to notify the passengers just in time, (i.e. when they have to leave home/office, or a few minutes before). Security is provided by making proposals and requests accessible only to work colleagues and disclosing personal information (i.e., where the car is parked, when leaving home, etc.) only to ride sharing colleagues and exploiting recent spatial information, using GPS indication of car parking place.

According to systems and methods herein, a carpooling system offers additional functionality in order to remain flexible with respect to time and location. Proposed trips may be confirmed at the very last moment, with the final details of the ride. As such, systems and methods herein can be added to existing carpooling systems addressing people leaving or arriving from the same place, as it can be applied to the various types of ride: recurrent, occasional, or real-time.

According to a computer implemented method of forming carpools, lists of participants in a rideshare environment are maintained. The participants on the list of participants are members of a private group and have privileges based on membership in the private group. A location of a participant is automatically determined based on a location detection method, using a computerized device. The driver proposes, using the computerized device, a trip comprising an approximate start time, approximate start location, end location, and number of available seats. Requests for transportation are received from passengers, using the computerized device. The passengers are participants on the list of participants. For each available seat, the requests for transportation are automatically matched with the trip based on the approximate start time, the approximate start location, or the end location, using the computerized device. Only certain passengers are matched with certain drivers based on the privileges. The matching identifies proposed riders. A finalized start time and finalized start location are negotiated between the proposed riders and the driver, using the computerized device. The driver publishes the finalized start time and finalized start location, using the computerized device. The proposed riders are automatically notified, using the computerized device, the finalized start time, and the finalized start location.

According to a mobile device herein, the mobile device includes a processor connected to a database. The database comprises lists of participants in a rideshare environment. A display interface is connected to the processor. A location detection device is connected to the processor. And a communication device is connected to the processor. The mobile device includes a computer readable storage medium having program instructions embodied therewith. The program instructions are readable/executable by the processor, to cause the processor to perform a method. The method comprises indicating, using the display interface, spare transport capacity for a driver of a vehicle. The driver is a participant on the list of participants. A proposed trip by the driver is displayed, using the display interface. The trip comprises an approximate start time, approximate start location, and end location. A request for transportation from a participant matched by a centralized server is received, using the communication device. The request is matched based on the spare transport capacity and the proposed trip. The centralized server is accessible only by participants on the list of participants. The request for transportation comprises a proposed start time different from the approximate start time or a proposed start location different from the approximate start location. A finalized start time and finalized start location are received from the driver, using the display interface. The finalized start time and the finalized start location are transmitted to the centralized server, using the communication device.

According to a system herein, the system comprises a database, a centralized processor connected to the database, a communications unit connected to the centralized processor, and a communication network connected to the communications unit. The database maintains a list of drivers and a list of passengers in a carpool program among colleagues in a work environment. The list of drivers includes an indication of spare transport capacity for each driver. The centralized processor matches a request for transportation from a passenger on the list of passengers with a trip proposed by a driver on the list of drivers, based on the indication of spare transport capacity and approximate start time, approximate start location, or end location provided by the driver. The matching identifies a proposed rider. The centralized processor transmits identification of the proposed rider to the driver and identification of the driver to the proposed rider, using the communications unit. The centralized processor facilitates negotiation between the proposed rider and the driver, using the communication network. The negotiation includes a proposed start time different from the approximate start time or a proposed start location different from the approximate start location. The proposed rider proposes the proposed start time or the proposed start location. The centralized processor receives a finalized start time and finalized start location from the driver. The centralized processor transmits the finalized start time and the finalized start location to the proposed rider, using the communications unit.

### BRIEF DESCRIPTION OF THE DRAWINGS

The systems and methods herein will be better understood from the following detailed description with reference to the drawings, which are not necessarily drawn to scale, and in which:

FIG. 1 is a block diagram according to systems and methods herein;

FIG. 2 is a block diagram of a map illustrating various aspects of systems and methods herein;

FIG. 3 is a flow diagram illustrating a first aspect of methods herein;

FIG. 4 is a flow diagram illustrating a second aspect of methods herein;

FIG. 5 is a flow diagram illustrating a third aspect of methods herein;

FIG. 6 is an illustration of a user interface according to systems and methods herein;

FIG. 7 is a flow diagram illustrating methods herein;

FIG. 8 is a schematic diagram illustrating devices herein; and

FIG. 9 is a schematic diagram illustrating devices herein.

### DETAILED DESCRIPTION

For a general understanding of the features of the disclosure, reference is made to the drawings. In the drawings, like reference numerals have been used throughout to identify identical elements. It will be readily understood that the systems and methods of the present disclosure, as generally described and illustrated in the drawings herein, may be arranged and designed in a wide variety of different configurations in addition to the systems and methods described herein. Thus, the following detailed description of the systems and methods, as represented in the drawings, is not intended to limit the scope defined by the appended claims, but is merely representative of selected systems and methods. The following description is intended only by way of example, and simply illustrates certain concepts of the systems and methods, as disclosed and claimed herein.

As noted above, a “carpool” is when two or more people share a trip in the same vehicle between an origination area and a destination area. For participants who work at the same general location, a carpool can be worked out to provide transportation needs in a flexible manner with respect to both location and time.

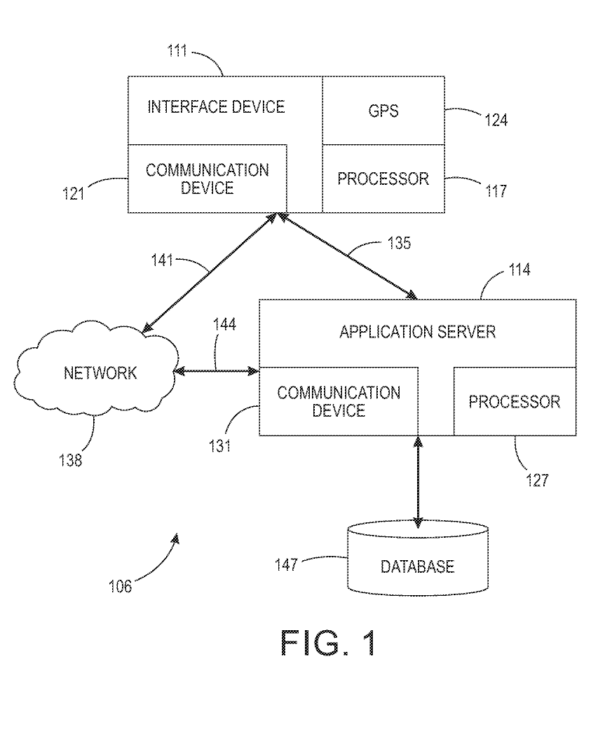

FIG. 1 is a general functional block diagram of a system, indicated generally as 106, for enabling ride sharing. The system 106 includes an interface device 111 in communication with an application server 114. The interface device 111 comprises a processor 117, a communication device 119, and a positioning unit, such as a GPS device 124. The processor 117 may comprise any form of processor as described in further detail below. The processor 117 can be programmed with appropriate application software to implement the methods described herein. It is specifically contemplated that the interface device 111 may comprise, for example, a GPS-enabled cell phone, a desktop or laptop computer, a tablet, and the like. Such devices commonly include input/output devices, power supplies, processors, electronic storage memories, wiring, etc., the details of which are omitted herefrom to allow the reader to focus on the salient aspects of the systems and methods described herein.

The application server 114 also comprises a processor 127 and a communication device 131. The processor 127 may comprise any form of processor as described in further detail below. Again, the processor 127 can be programmed with appropriate application software embodied therewith, which software is readable and executable by the processor 127, as described in further detail below.

The application server 114 may communicate with the interface device 111 directly, as indicated by communication link 135. Alternatively, the application server 114 may communicate with the interface device 111 over network 138, such as indicated by communication links 141, 144. The network 138 comprises a communication network either internal or external, for affecting communication between the interface device 111 and the application server 114. For example, network 138 may comprise a local area network (LAN) or a global computer network, such as the Internet. It is specifically contemplated that the interface device 111 may communicate with the application server 114 wirelessly, using a wireless network. In particular, network 138 may comprise a cellular data network.

The system 106 includes a database 147 in communication with the application server 114. The database 147 includes any conventional database or any set of records or data that contains configuration information about individual carpools. Database 147 may comprise any organized collection of data operating with any type of database management system. The database 147 may contain datasets comprising multi-relational data elements.

The system described herein facilitates carpooling for recurrent journeys in a work context, to permit colleagues to share rides from their homes to their workplace and vice-versa. The method described herein allows users to organize work related carpooling with colleagues in a flexible manner with respect to both location and time. More precisely, the system and method allows the users to organize shared trips in multiple steps: initially a trip is proposed/requested only with approximate time and location; the system then supports adjusting and specifying the precise trip time and location in subsequent steps, even at the last minute, right before the trip starts.

Flexibility with respect to location: the system herein may use GPS-enabled devices (e.g. Smartphones), which allows dynamically publishing geographical information, typically where a car is parked. The system can then use that location together with other geographical information to facilitate carpooling (to identify possible carpooling passengers for instance, or to guide everyone to the parking place as a meeting place).

Flexibility with respect to time: the system facilitates flexible and last minute carpooling through the possibility for the driver to specify the precise departure time later, until just right before departure, notifying and alerting the passengers in real time about their booked rides or about rides matching their usual needs. This functionality is particularly useful in work organizations with flexible working hours where people are not able or do not want to commit on their schedules too much in advance.

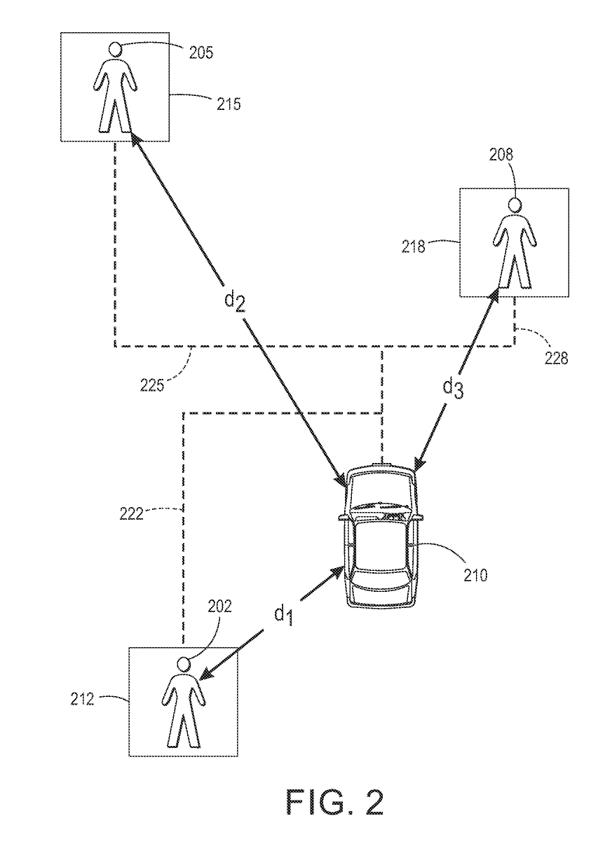

Referring now to FIG. 2, a driver 202 and two passengers 205, 208 are members of a car pool that travels in a single vehicle 210 to a common work environment. In the example shown in FIG. 2, the driver 202 and passengers 205, 208 are employed at the same general location, with each having their own work location 212, 215, and 218, respectively. Each work location 212, 215, and 218, may be some distance d₁, d₂, d₃ away from the vehicle 210. The driver 202 proposes a departure time for a trip to return home. The driver proposes an approximate start time, approximate start location, and number of available seats. If necessary, the passengers 205, 208 and driver 202 negotiate a finalized start time and finalized start location. According to systems and methods herein, the location of the vehicle 210 may be automatically determined by a GPS system when the vehicle 210 is parked. Once the finalized start time and finalized start location are determined, the processor 127 (FIG. 1) determines a path (indicated by broken line 222) that the driver 202 may travel to get from his/her present work location 212 to the vehicle 210. The processor 127 automatically determines the amount of time required for the driver 202 to travel the path 222 between the driver's work location 212 and the location of the vehicle 210. The processor 127 accounts for the speed of the driver 202 and obstacles, such as stairs, buildings, etc. in determining the amount of time required for the driver 202 to travel the path 222 between the driver's work location 212 and the location of the vehicle 210. Based on the finalized start time and the amount of time required for the driver 202 to travel the path 222 between the driver's work location 212 and the location of the vehicle 210, the system automatically provides the driver 202 with a warning using the interface device. Similarly, the processor 127 (FIG. 1) determines the paths (indicated by broken lines 225, 228) that the passengers 205, 208 may travel to get from his/her present work location 215, 218, respectively, to the vehicle 210. The processor 127 automatically determines the amount of time required for the passengers 205, 208 to travel the respective paths 225, 228 between the work location 215, 218 and the location of the vehicle 210. The processor 127 accounts for the speed of the passengers 205, 208 and obstacles, such as stairs, buildings, etc. in determining the amount of time required for the passengers 205, 208 to travel the respective paths 225, 228. Based on the finalized start time and the amount of time required for the passengers 205, 208 to travel the respective paths 225, 228, the system automatically provides the passengers 205, 208 with a warning using the interface device. As mentioned above, it is contemplated that the interface device may comprise a GPS-enabled cell phone, but other wireless communications devices using different location tracking technology can also work, such as personal digital assistants with GPS daughter cards and cell phones that obtain location information from triangulation of cellular antenna towers, may be used in order to track the driver 202 and passengers 205, 208 as they travel along their respective path 222, 225, 228.

Employees have typical commuting patterns, for example, in office environments; they typically commute from home to work in the morning, and from work back home in the evening. For employees with flexible working hours, these recurrent patterns can be defined in terms of approximate space and time. Taking into account this recurrent approximate nature, the system and method herein enables flexible ride sharing, allowing organizing rides in multiple phases: initially, rides are proposed, requested, and agreed upon in approximate space and time; for each individual trip, the exact time and meeting location of is then specified at a later stage, possibly just before the trip starts.

Systems and methods herein support three types of flexible rides:
1. Recurrent flexible rides, i.e. periodically recurrent agreed rides with the same driver and passenger(s).
2. Occasional flexible rides, i.e. rides that are agreed upon in advance, on a ride-by-ride basis, and in a non-regular fashion. These rides do not necessarily involve the same driver and passenger(s).
3. Last-minute flexible rides, i.e. rides that are agreed upon in the last minute, just before the trip starts, on a first-come- first-served basis.

The system manages these different types of rides and interacts with the driver and the passenger(s). During all these interactions, the system exploits the users' typical commuting patterns to simplify the interaction with the carpooling system. Indeed, depending on the user's typical commuting pattern and the actual time when she connects to the system, the system will adapt the information and functionality it provides to the typical needs of that user at that time. For example, if a user has an upcoming recurrent flexible ride, the system will show the information associated to that upcoming ride and the user will be able to act on it (e.g. specify the precise departure location or time).

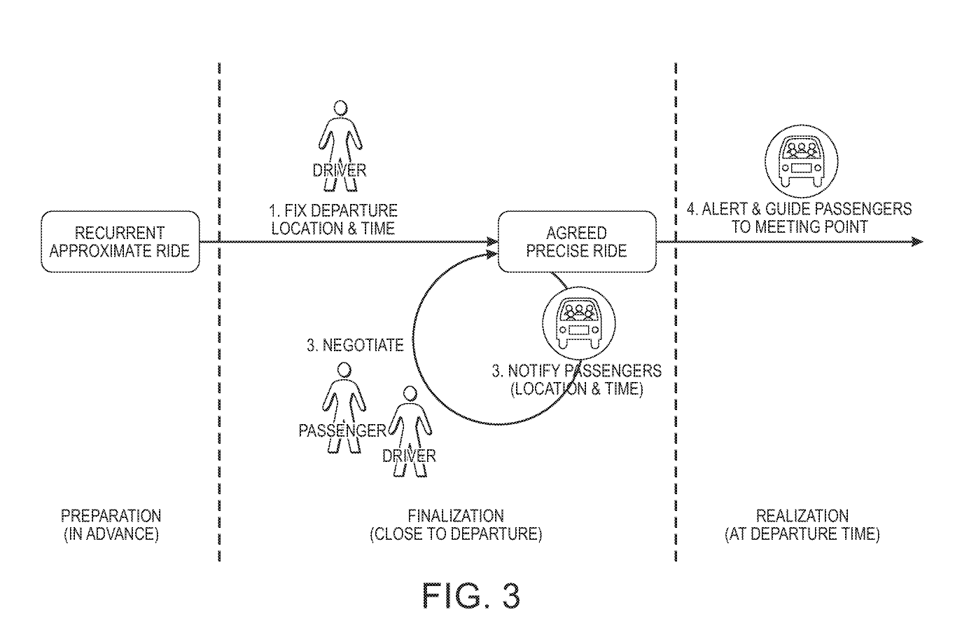

Referring to FIG. 3, once recurrent flexible rides involving a particular driver and one or more passengers are setup, the main functionality of the system is to support the finalization of the individual trips, i.e. the specification and possible negotiation among the ride sharing partners of the exact time and location of each individual trip.

As shown in FIG. 3, the meeting point/departure location and time are published (both can be fixed and finalized at the same time or in subsequent steps):
a. The departure location of a trip is defined by default, for instance the driver's home location for home to work trips. For each individual trip, the driver may replace the default location by a different location, e.g. when parking the car in the evening, the driver may publish the actual parking's GPS location to the system to use as departure location for next morning's trip to work. At the same time, the driver may modify the approximate departure time and the number of available seats for that trip.
b. When the driver is in the position to estimate precisely his departure time, he notifies the system. For instance, in the morning, when ready, he notifies the system that he is about to leave. Estimating the walking time to the parking place, the system computes the estimated departure time from the parking place.

The system notifies the passenger(s) about the updated departure location and time of the upcoming trip.

In case a passenger has a problem to join the trip at the proposed time, he can negotiate with the driver (and the other car sharing partners). The passenger can:
a. Notify the driver, asking for a delay (e.g. leave 10 min later), or
b. Declare that he cannot join the ride and releases his seat. In that case, the system may make this seat available for last minute arrangements (see below).
   In the first case, if the proposed departure time is still significantly ahead, and as long as the delay is within the previously specified approximate time interval, the driver may in reaction adapt and update the departure time and let the system notify all passengers. If either the driver declines to make a change or does not react until close to departure time, the system releases the passenger's seat similar to case b.

Finally, the system alerts the passengers, when they have to leave home (or office) to meet the driver at the departure location, including their estimated walking time to the meeting place. If required, it guides the riders to the precise meeting place.

The system herein exploits the typical work related travel patterns of its users. Initial patterns can be set to default values. For instance, the system can fill users' default home location and default (flexible) working hours. These can be adjusted by the users and, over time, by the system. Over time, the system also learns which users typically offer rides (i.e. are drivers) or request rides (i.e. are passengers).

The system then adapts the functionality proposed to its users depending on the current context. According to the actual time a user connects, the system can assume the most probable next ride the user is willing to offer/request (the ride from home to work in the morning or the ride home from work in the evening). For instance, if a user logs in into the system in the afternoon, the system assumes that, according to the user's typical pattern, she is searching for a ride home from work in the evening, and directly provides her with an overview of the corresponding matching proposals. (However, if the user searches for another ride, she may adapt the filter to her purpose.)

According to systems and methods herein, the system provides drivers with an overview of a) the typical and b) the actual requests within the system that match their offer. A driver may then respond to actual requests (if any) or offer the ride, in general. This functionality is similar to what is provided in traditional car sharing systems, but with the possibility of specifying only an approximate ride time and space.

Further, according to systems and methods herein, the system provides passengers with an overview of a) the typical and b) the actual offers within the system that match their request. A passenger may then respond to an actual offer or request a ride, in general. Again, this functionality is similar to what is provided in traditional car sharing systems, but with the possibility of specifying only an approximate ride time and space.

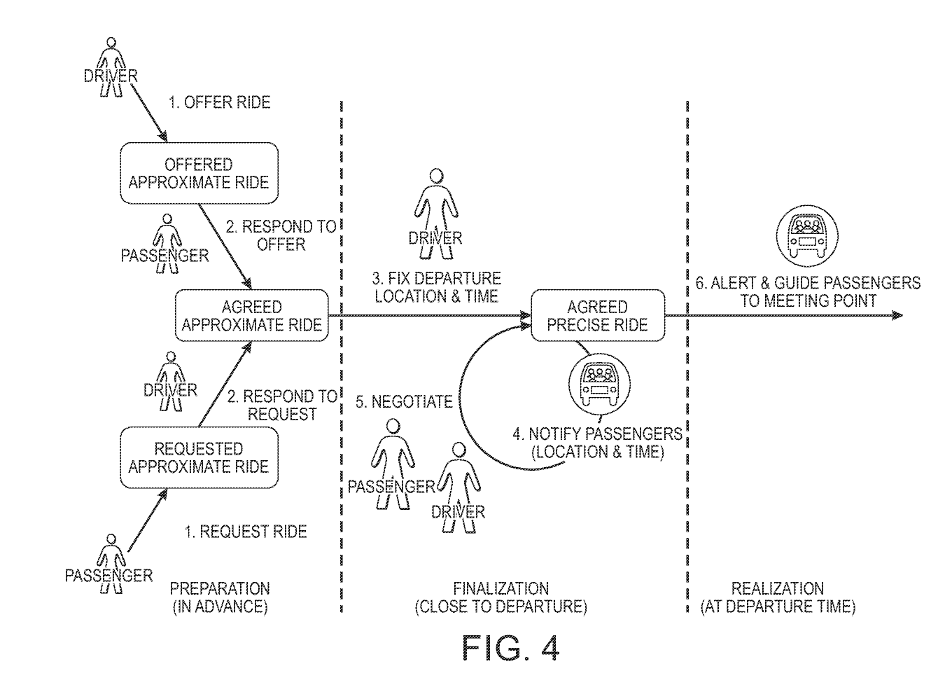

As shown in FIG. 4, occasional rides can be booked in advance through a mutual agreement between the driver and the passenger(s). A driver can offer a ride and/or a passenger can request a ride. The driver may respond directly to the passenger's request and/or the passenger can respond to the driver's offer. Once a driver and a passenger have agreed on the ride, the system handles and finalizes an occasional planned ride as described above. To simplify the process and the interaction required, in order to get rid of the mutual agreement step, the driver and the passenger may agree to transform an occasional ride into a recurrent ride.

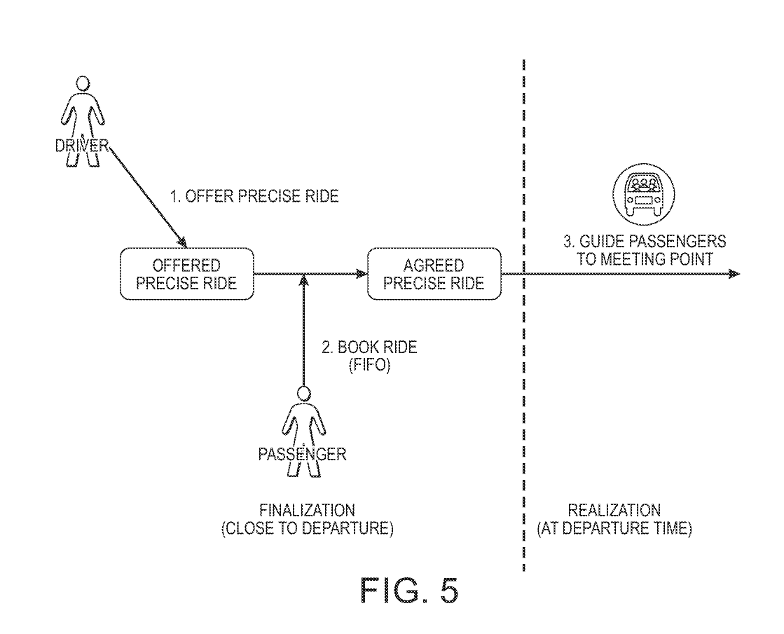

FIG. 5 shows an example of the handling process for “last minute” rides. If drivers or passengers either cannot commit in advance or want/need to keep maximum flexibility up to the last moment, the system allows arranging last minute rides. Here the driver may offer a ride right before his departure and passengers may monitor/request alerts on relevant offers in real time. Passengers can react on those offers and book the corresponding ride immediately. The system handles these bookings in a first-come first-served manner, and notifies/confirms the accepted bookings to the driver and the passengers, in real time.

It is contemplated that communication between the driver and passenger may be conducted using any appropriate method now known or developed in the future, such as voice, text, SMS, MMS, etc.

Systems and methods have been described herein with reference to the application server 114 interacting with a single carpool, but it is desirable for the application server 114 to be able to support many carpools. Furthermore, the application server 114 may support more than one cellular carrier, even when carriers use different location tracking technologies.

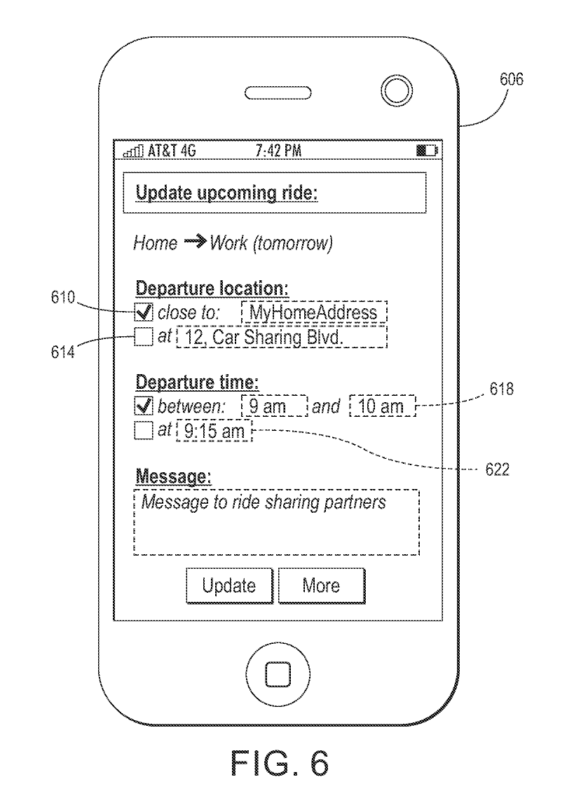

FIG. 6 illustrates an example of a possible interface device embodied in a smartphone 606. The system interface may be accessed via the smartphone 606. Such a display may be provided when the driver connects through her mobile phone in the evening before an upcoming recurring flexible ride from home to work. As shown in FIG. 6, the user has a soon upcoming ride as driver. The system automatically proposes an approximate location as the home address 610. The system can be established to default the home address as the approximate location for a home to work trip. Alternatively, the system can automatically propose a precise location based on a GPS or other positioning fix when parking the vehicle 614. The system can automatically propose an approximate departure time 618. The automatic time may default to a time based on historical departure times and/or calculated based on the approximate travel time from home to work. Alternatively, the system can compute and propose a precise time 622, particularly if the trip is imminent. The precise time can be calculated based on the current time and the estimated time for travel to the location of the vehicle, as described with reference to FIG. 2. Thus, when a user connects to the system, the interface device 111 directly allows her to update this ride, for instance to choose her current (parking) location as departure and meeting point, or to notify her passengers about the final departure time.

If the user has no upcoming recurrent flexible ride, the system may provide her with the list of ride offers/requests matching her pattern (see section on handling occasional and last minute flexible rides).

To reach a destination location from a departure location, several alternative itineraries may exist. Often carpooling partners do not share the whole ride, but only partial rides. A partial ride involves the existence of an intermediate stop location, reducing in turn the number of appropriate alternative itineraries for the overall ride to those going through that intermediate stop location. Taking into account the resulting refined itinerary, the system improves the matching of ride sharing partners. For instance, if two drivers propose rides from work to the center of town, and 4 passengers want a partial ride with different stops, the system automatically groups the car share ride partners in groups with corresponding disjoint, optimal itineraries.

Riders can specify, modify, and finalize their offers through the system. Similarly, passengers can negotiate with their driver on last minute changes and adaptations to their schedule, or declare they drop out of an already agreed ride. The system tracks these interactions and can learn over time punctuality/reliability of drivers/passengers. These characteristics can then be used as implicit criteria for matching partners. In case, for instance, a passenger requires a ride with high punctuality and reliability he might specify this in his request; in consequence, the system will only propose sufficiently reliable drivers.

Apart from the inherent advantages of carpooling, such as the reduction of traffic congestion, air pollution, stress, etc., the system can handle a company-based rewarding scheme for car sharing drivers in order to provide incentives to motivate people, especially drivers, to participate to such initiatives. There are many carpooling incentive programs in a wide range of countries, either governmental or company-based, that propose to reward carpoolers. These incentives mostly consist of one-off discounts that can be used for (future) rides as car sharing passengers. Another option is to incentivize drivers through corporate subsidies, for example reimbursing part of their fuel expenses or parking costs, depending on their recurring car sharing behavior.

To support such incentives, the system needs to track that behavior. The system described herein can easily track the number of times a driver proposes and effectively shares trips, with how many colleagues, and if this happens on a regular basis (e.g. monthly, quarterly, annually . . . ). This information can then be used by the work organization to reward the drivers, for example by reimbursing part of their expenses. Over time, the system also learns which types of rides are most searched for in terms of time and location. In consequence, the system can adapt the proposed incentives such that drivers become inclined to adapt to the observed needs.

Providing incentives rewarding car sharing among employees will also encourage people to register and organize their trips through the system. This allows the company to follow the evolution and to verify the success of the car sharing effort, and to track its progress towards its sustainability goals.

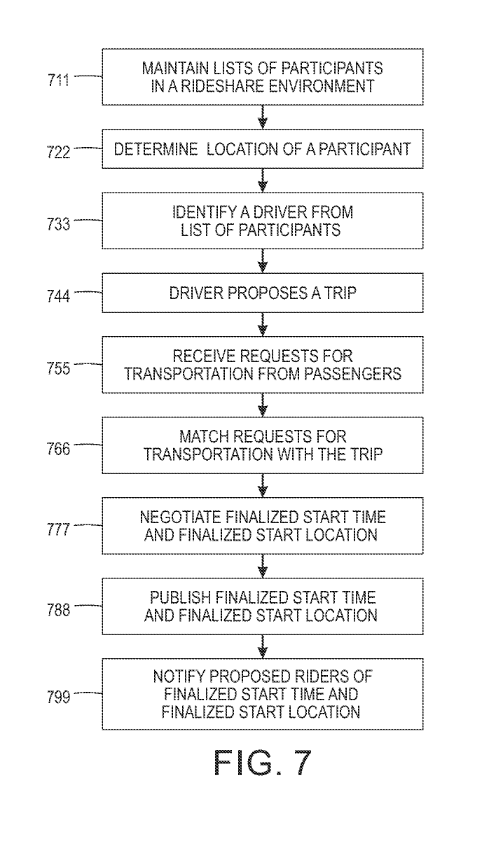

FIG. 7 is a flow diagram illustrating the processing flow of an exemplary method of forming carpools according to systems and methods herein. At 711, lists of participants in a rideshare environment are maintained. The participants on the list of participants are members of a private group and have privileges based on membership in the private group. A location of a participant is automatically determined based on a location detection method, at 722. A driver (from the list of participants 733) proposes a trip comprising an approximate start time, approximate start location, end location, and number of available seats in item 744. Requests for transportation are received from passengers, at 755. The passengers are participants on the list of participants. For each available seat, the requests for transportation are automatically matched with the trip, at 766. The requests for transportation are matched based on the approximate start time, the approximate start location, or the end location. Only certain passengers are matched with certain drivers based on the privileges. The matching identifies proposed riders. A finalized start time and finalized start location are negotiated between the proposed riders and the driver, at 777. The driver publishes the finalized start time and finalized start location, at 788. At 799, the proposed riders are automatically notified of the finalized start time and the finalized start location.

Aspects of the present disclosure are described herein with reference to flowchart illustrations and/or block diagrams of methods, apparatus (systems), and computer program products according to various devices and methods. It will be understood that each block of the flowchart illustrations and/or two-dimensional block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In case of implementing the devices and methods herein by software and/or firmware, a program constituting the software may be installed into a computer with dedicated hardware, from a storage medium or a network, and the computer is capable of performing various functions if with various programs installed therein.

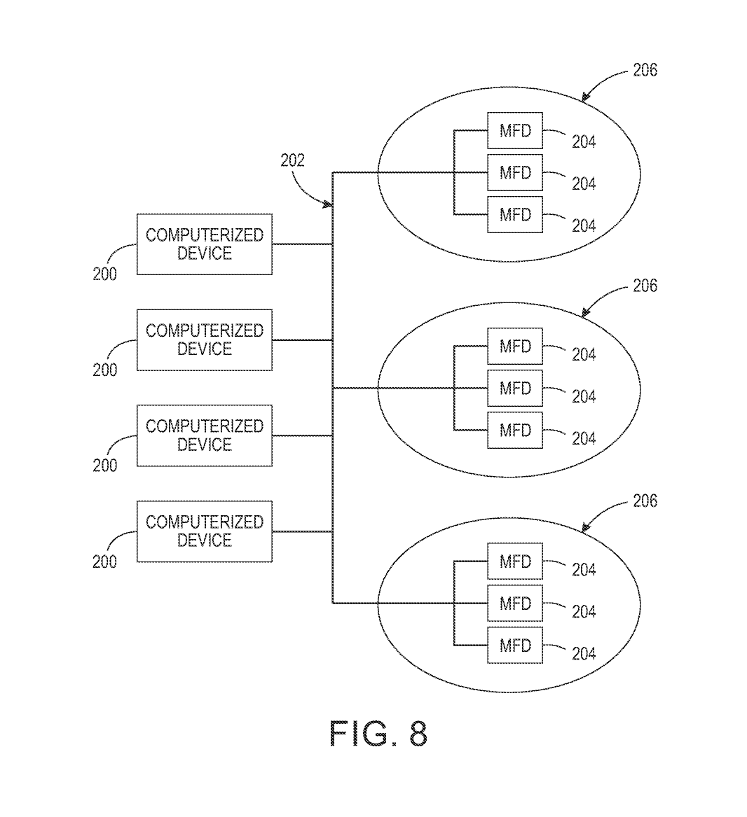

As shown in FIG. 8, exemplary systems and methods herein include various computerized devices 200, 204 located at various different physical locations 206. The computerized devices 200, 204 can include print servers, printing devices, personal computers, etc., and are in communication (operatively connected to one another) by way of a local or wide area (wired or wireless) network 202.

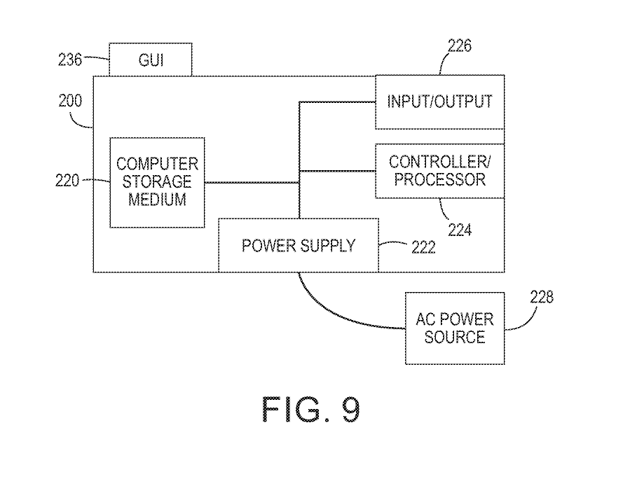

FIG. 9 illustrates a computerized device 200, which can be used with systems and methods herein and can comprise, for example, a print server, a personal computer, a portable computing device, etc. The computerized device 200 includes a controller/tangible processor 224 and a communications port (input/output) 226 operatively connected to the tangible processor 224 and to the computerized network 202 external to the computerized device 200. Also, the computerized device 200 can include at least one accessory functional component, such as a graphic user interface assembly 236 that also operate on the power supplied from the external power source 228 (through the power supply 222).

The input/output device 226 is used for communications to and from the computerized device 200. The tangible processor 224 controls the various actions of the computerized device. A non-transitory computer storage medium device 220 (which can be optical, magnetic, capacitor based, etc.) is readable by the tangible processor 224 and stores instructions that the tangible processor 224 executes to allow the computerized device to perform its various functions, such as those described herein. Thus, as shown in FIG. 3, a body housing has one or more functional components that operate on power supplied from an alternating current (AC) source 228 by the power supply 222. The power supply 222 can comprise a power storage element (e.g., a battery, etc).

The terminology used herein is for the purpose of describing particular systems and methods only and is not intended to be limiting of this disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, the terms automated or automatically mean that once a process is started (by a machine or a user), one or more machines perform the process without further input from any user.

The corresponding structures, materials, acts, and equivalents of all means or step plus function elements in the claims below are intended to include any structure, material, or act for performing the function in combination with other claimed elements as specifically claimed. The descriptions of the various systems and methods herein have been presented for purposes of illustration, but are not intended to be exhaustive or limited to the systems and methods disclosed. Many modifications and variations will be apparent to those of ordinary skill in the art without departing from the scope and spirit of the described systems and methods. The terminology used herein was chosen to best explain the principles of the systems and methods, the practical application or technical improvement over technologies found in the marketplace, or to enable others of ordinary skill in the art to understand the systems and methods disclosed herein.

What is claimed is:

1. A computer implemented method of forming carpools, comprising:
maintaining lists of participants in a rideshare environment, participants on said list of participants being members of a private group and having privileges based on membership in said private group;
automatically determining a location of a participant, based on a location detection method, using a computerized device;
one of said participants comprising a driver, said driver proposing, using said computerized device, a trip comprising an approximate start time, approximate start location, end location, and number of available seats;
receiving, using said computerized device, requests for transportation from passengers, said passengers being participants on said list of participants;
for each available seat, automatically matching, using said computerized device, said requests for transportation with said trip based on said approximate start time, said approximate start location, or said end location, said matching identifying proposed riders;
negotiating between said proposed riders and said driver a finalized start time and finalized start location, using said computerized device;
said driver publishing, using said computerized device, said finalized start time and finalized start location; and
automatically notifying said proposed riders, using said computerized device, said finalized start time and said finalized start location.

2. The method according to claim 1, further comprising:
tracking the location of each proposed rider, using said computerized device;
for each proposed rider, calculating the distance between said proposed rider and said finalized start location and determining the amount of time for said proposed rider to travel said distance; and
warning said proposed rider when said amount of time for said proposed rider to travel said distance is less than or equal to an amount of time remaining before said finalized start time.

3. The method according to claim 1, said automatically notifying said proposed riders further comprising automatically providing time and location information on a communications device to all proposed riders.

4. The method according to claim 1, said automatically matching said requests for transportation with said trip further comprising automatically providing said proposed riders an identification of said driver and automatically providing said driver an identification of said proposed riders.

5. The method according to claim 4, said providing said proposed riders an identification of said driver further comprising establishing a communication connection between said proposed riders and said driver.

6. The method according to claim 1, said automatically matching said requests for transportation with said trip further comprising:
determining said approximate start location and said end location;
determining current locations of a plurality of passengers; and
identifying at least one of said plurality of passengers as a candidate rider based on the current locations of said plurality of passengers and said end location.

7. The method according to claim 1, only certain passengers being matched with certain drivers based on said privileges.

8. A mobile device, comprising:
a processor connected to a database comprising lists of participants in a rideshare environment;
a display interface connected to said processor;
a location detection device connected to said processor;
a communication device connected to said processor; and
a computer readable storage medium having program instructions embodied therewith, the program instructions being readable/executable by said processor, to cause said processor to perform a method comprising:
indicating, using said display interface, spare transport capacity for a driver of a vehicle, said driver being a participant on said list of participants;
displaying, using said display interface, a proposed trip by said driver, said trip comprising an approximate start time, approximate start location, and end location;
receiving, using said communication device, a request for transportation from a participant matched by a server based on said spare transport capacity and said proposed trip, said server being accessible only by participants on said list of participants, said request for transportation comprising a proposed start time different from said approximate start time or a proposed start location different from said approximate start location;
receiving, using said display interface, a finalized start time and finalized start location from said driver; and
transmitting to said server, using said communication device, said finalized start time and said finalized start location.

9. The mobile device according to claim 8, said location detection device comprising a GPS device.

10. The mobile device according to claim 8, said method further comprising:
tracking the location of a user of said mobile device;
calculating the distance between said location of said user and said finalized start location and determining the amount of time for said user to travel said distance; and
warning said user when said amount of time for said user to travel said distance is less than or equal to an amount of time remaining before said finalized start time.

11. The mobile device according to claim 8, said server being connected to said database comprising said lists of participants in said rideshare environment.

12. The mobile device according to claim 8, said communication device comprising an SMS device.

13. The mobile device according to claim 8, said receiving a request for transportation further comprising receiving an identification of said participant.

14. The mobile device according to claim 8, only certain passengers being matched with certain drivers.

15. A system, comprising:
a database;
a processor connected to said database;
a communications unit connected to said processor; and
a communication network connected to said communications unit,
said database maintaining a list of drivers and a list of passengers in a carpool program among colleagues in a work environment, said list of drivers including indication of spare transport capacity for each driver,
said processor matching a request for transportation from a passenger on said list of passengers with a trip proposed by a driver on said list of drivers based on said indication of spare transport capacity and approximate start time, approximate start location, or end location provided by said driver, said matching identifying a proposed rider,
said processor transmitting, using said communications unit, identification of said proposed rider to said driver and identification of said driver to said proposed rider,
said processor facilitating, using said communication network, negotiation between said proposed rider and said driver a proposed start time different from said approximate start time or a proposed start location different from said approximate start location, said proposed start time or said proposed start location being proposed by said proposed rider,
said processor receiving a finalized start time and finalized start location from said driver, and
said processor transmitting, using said communications unit, said finalized start time and said finalized start location to said proposed rider.

16. The system according to claim 15, said communications unit further comprising:
a location detection device; and
a processor.

17. The system according to claim 16, further comprising:
said communications unit tracking the location of said proposed rider;
said processor of said communications unit calculating the distance between said proposed rider and said finalized start location and determining the amount of time for said proposed rider to travel said distance; and
said communications unit warning said proposed rider when said amount of time for said proposed rider to travel said distance is less than or equal to an amount of time remaining before said finalized start time.

18. The system according to claim 15, said processor matching said request for transportation further comprising:
determining said approximate start location and said end location;
determining current locations of a plurality of passengers; and
identifying at least one of said plurality of passengers as a proposed rider based on the current locations of said plurality of passengers and said end location.

19. The system according to claim 15, said processor matching only certain passengers with certain drivers.

20. The system according to claim 15, said processor establishing a communication connection between said proposed rider and said driver.
